(19) United States
(12) Patent Application Publication
(10) Pub. No.: US 2008/0298926 A1
(43) Pub. Date: Dec. 4, 2008

(54) Fastener Assembly

(76) Inventor: John Edward Feuerstein, Lafayette, CA (US)

Correspondence Address: QUARLES & BRADY LLP, 411 E. WISCONSIN AVENUE, SUITE 2040, MILWAUKEE, WI, 53202-4497, US

(21) Appl. No.: 11/756,178

(22) Filed: May 31, 2007

(51) Int. Cl. F16B 19/00

(52) U.S. Cl. 411/354

(57) ABSTRACT

The present invention comprises a fastener assembly and method of use for securing first and second members. The assembly comprises a linker having a first bearing surface and a stop surface substantially perpendicular to the linker and having threaded securing opening, and a fastener. The fastener has a wedge member and a securing member where the wedge member forms substantially oppositely facing wedge and jamb surfaces. Alternative embodiments of the fastener assembly are also included.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention is fastener assemblies for securing first and second tubes together.

In the furniture industry generally and more specifically in the office furniture and medical facility furniture industries, panel and other furniture systems have been designed that include, among other components, tubes that have to be connected together in either a side by side fashion or in an end to side fashion. For instance, in some applications, hollow tubes that have a rectilinear cross section may be used to form frames for panel assemblies, desk components, shelving assemblies, etc. In these applications, one important factor when determining how best to secure one tube to another is the aesthetic result. To this end, to the extent possible it is advantageous if, after tubes are fastened, the connector is completely concealed.

One way to secure two tubes together has been to weld the tubes together. While welding certainly can secure one tube to another, welding is labor intensive, messy during the welding process and can, if not performed correctly, damage tubes that are being connected. In addition, weld points can often be seen after welds are complete which adversely affects aesthetics. Moreover, once tubes are welded, the tubes cannot easily be separated and therefore, when mistakes are made or when a configuration change is desired, costs can rise quickly.

Another way to secure two tubes together has been by using mechanical connector assemblies. While many mechanical tube connector assemblies are known, each known assembly suffers from one or more shortcomings including but not limited to effectiveness in creating a tight fit between tubes, robustness, ease of installation, aesthetic result (i.e., in many cases parts of a mechanical fastener are exposed after tubes are connected), etc.

Thus, it would be advantageous to have one or more connector assemblies or fasteners for fastening two tubes together where the fastener is simple and robust in design, where the fastener can create a tight fit between two tubes, where the fastener is easy to install and remove and where the fastener, after installation, is substantially hidden from sight.

### BRIEF SUMMARY OF THE INVENTION

Several different embodiments of inventive fastener assemblies have been developed that each rely on the combination of a bolt/fastener and a wedge or clip member to draw a linker, pin or tab that is secured to a first member through a hole formed by a second member until facing surfaces of the first and second members abut and are held together. Here the fastener is adjustable to increase the force between the first and second members and the fastener effectively locks the members together unless affirmatively loosened. In embodiments that include a wedge member, the fastener forces the wedge member between a linker or pin bearing surface and a surface formed by the second member that substantially faces the bearing surface to draw the first member toward the second member. In embodiments that include a tab and a clip member, the fastener cooperates with the tab to force portions of the clip member against a surface formed by the second member to draw the first member toward the second member.

Consistent with the above, some inventive embodiments include a fastener assembly for use with first and second members that each include first and second oppositely facing surfaces where the first member forms a first member opening between the first and second surfaces of the first member and the second member forms a second member opening between the first and second surfaces of the second member, the assembly for securing the first member to the second member with the first surface of the first member abutting the first surface of the second member, the assembly comprising a linker having a linker length dimension between first and second ends and having a first bearing surface and a substantially oppositely facing first stop surface that are substantially perpendicular to the linker length dimension and a fastener including a wedge member and a securing member, the wedge member forming substantially oppositely facing wedge and jamb surfaces and having a first end and a distal second end, where the wedge surface forms an acute angle with the jamb surface, the securing member extending from the first end of the wedge member and substantially parallel to the jamb surface and configured to engage the linker, wherein, with the first surface of the first member abutting the first surface of the second member and the first and second member openings substantially aligned, the linker is positionable to extend through the first and second member openings with the first stop surface abutting the second surface of the first member and the first bearing surface on the second surface side of the second member, the fastener positionable so that the wedge member is jammed in a securing position between the second surface of the second member and the bearing surface with the jamb surface and the wedge surface abutting the second surface of the second member and the bearing surface, respectively, and with the securing member engaged to the linker to maintain the wedge member in the securing position.

In some cases the linker forms a threaded securing opening and wherein the securing member includes a bolt including a head member and a threaded shaft that is receivable within the securing opening to secure the fastener to the linker. In some cases the wedge member forms a wedge opening and wherein the threaded shaft of the bolt extends through the wedge opening toward the threaded opening formed by the linker. In some cases each of the wedge surface and the jamb surface are substantially flat. In some embodiments the at least the second member is a tube member and wherein the first and second surfaces of the second member include substantially flat external and internal surfaces of the tube member, respectively. In some cases the first member is also a tube member and wherein the first and second surfaces of the first member include substantially flat external and internal surfaces of the tube member, respectively.

In some cases the linker includes a pin member that forms a pin opening for at least in part receiving the wedge member where the pin opening forms the bearing surface. In some cases the pin member is a cylindrical member. In some cases the pin member also forms a threaded securing opening and wherein the securing member includes a bolt including a head member and a threaded shaft that is receivable within the securing opening to secure the fastener to the linker.

In some cases the fastener, the wedge member, the securing member, the wedge surface, the jamb surface and the bearing surface are a first fastener, a first wedge member, a first securing member, a first wedge surface, a first jamb surface and a first bearing surface, respectively, and, wherein, the linker forms a second bearing surface that faces a direction substantially opposite the first bearing surface, the linker including a second fastener, the second fastener including a second wedge member and a second securing member, the second wedge member forming substantially oppositely facing second wedge and second jamb surfaces and having a first end and a distal second end, where the second wedge surface forms an acute angle with the second jamb surface and the second jamb surface forms the stop surface, the second securing member extending from the first end of the second wedge member and substantially parallel to the second jamb surface and configured to engage the linker, and, wherein, when the linker extends through the first and second member openings, the first and second bearing surfaces are on the second surface side of the second member and the second surface side of the first member, respectively, the second fastener positionable so that the second wedge member is jammed in a securing position between the second surface of the first member and the second bearing surface with the second jamb surface and the second wedge surface abutting the second surface of the first member and the second bearing surface, respectively, and with the second securing member engaged to the linker to maintain the second wedge member in the securing position.

In some embodiments the linker includes a pin member that forms at least a first pin opening for at least in part receiving the first and second wedge members where the pin opening forms the first and second bearing surfaces and wherein at least a portion of each of the first and second wedge members extends through the pin opening when the first and second wedge members are in the securing positions.

In some cases the pin member also forms first and second threaded securing openings and wherein the first and second securing members include first and second bolts including head members and a threaded shafts that are receivable within the first and second securing openings to secure the first and second fasteners to the linker, respectively.

In some embodiments the first and second wedge members form first and second wedge openings proximate the first ends of the first and second wedge members for passing the threaded shafts, the assembly further including first and second retainers that extend from portions of the threaded shafts adjacent the first and second wedge openings to retain the first and second bolts to the first and second wedge members, respectively.

In some cases the first and second members include first and second tube members and wherein the first and second surfaces of the first member include substantially flat external and internal surfaces of the first tube member, respectively, and, the first and second surfaces of the second member include substantially flat external and internal surfaces of the second tube member, respectively. In some embodiments the first and second threaded securing openings extend along substantially parallel trajectories.

In addition, some embodiments include a fastener assembly for use with first and second members that each include first and second oppositely facing surfaces where the first member forms a first member opening between the first and second surfaces of the first member and the second member forms a second member opening between the first and second surfaces of the second member, the assembly for securing the first member to the second member with the first surface of the first member abutting the first surface of the second member, the assembly comprising a linker pin member having a linker length dimension between first and second ends and forming first and second threaded and substantially parallel securing openings proximate the first and second ends, respectively, the linker pin also forming at least a first pin opening located between the first and second securing openings where the pin opening forms first and second oppositely facing bearing surfaces proximate the first and second securing openings, respectively, a first wedge member forming substantially oppositely facing first wedge and first jamb surfaces and having a first end and a distal second end, the first wedge surface forming an acute angle with the first jamb surface, the first wedge member forming a first wedge opening that extends along a trajectory that is substantially parallel to the first jamb surface, a second wedge member forming substantially oppositely facing second wedge and second jamb surfaces and having a first end and a distal second end, the second wedge surface forming an acute angle with the second jamb surface, the second wedge member forming a second wedge opening that extends along a trajectory that is substantially parallel to the second jamb surface, a first bolt having a first head member and a first threaded shaft that extends from the first head member, a second bolt having a second head member and a second threaded shaft that extends from the second head member, wherein, with the first surface of the first member abutting the first surface of the second member and the first and second member openings substantially aligned, the linker pin member is positionable to extend through the first and second member openings with the first and second bearing surfaces on the second surface side of the second member and the second surface side of the first member, respectively, the first wedge member positionable in a securing position between the second surface of the second member and the first bearing surface with the first jamb surface and the first wedge surface abutting the second surface of the second member and the first bearing surface, respectively, the second wedge member positionable in a securing position between the second surface of the first member and the second bearing surface with the second jamb surface and the second wedge surface abutting the second surface of the first member and the second bearing surface, respectively and, wherein, the first threaded shaft is positionable to pass through the first wedge opening and is receivable within the first threaded securing opening formed by the linker pin member to secure the first wedge member in the securing position and the second threaded shaft is positionable to pass through the second wedge opening and is receivable within the second threaded securing opening formed by the linker pin member to secure the second wedge member in the securing position.

In some cases each of the wedge surfaces and the jamb surfaces is substantially flat. In some cases the first and second members include first and second tube members and wherein the first and second surfaces of the first member include substantially flat external and internal surfaces of the first tube member, respectively, and, the first and second surfaces of the second member include substantially flat external and internal surfaces of the second tube member, respectively. In some cases the linker pin member is a cylindrical member.

Other embodiments include a method for use with first and second members that each include first and second oppositely facing surfaces where the first member forms a first member opening between the first and second surfaces of the first member and the second member forms a second member opening between the first and second surfaces of the second member, the method for securing the first member to the second member with the first surface of the first member abutting the first surface of the second member, the method comprising the steps of providing a linker pin member having a linker length dimension between first and second ends and forming first and second threaded and substantially parallel securing openings proximate the first and second ends, respectively, the linker pin also forming at least a first pin opening located between the first and second securing openings where the pin opening forms first and second oppositely facing bearing surfaces proximate the first and second securing openings, respectively, providing a first wedge member forming substantially oppositely facing first wedge and first jamb surfaces and having a first end and a distal second end, the first wedge surface forming an acute angle with the first jamb surface, the first wedge member forming a first wedge opening that extends along a trajectory that is substantially parallel to the first jamb surface, providing a second wedge member forming substantially oppositely facing second wedge and second jamb surfaces and having a first end and a distal second end, the second wedge surface forming an acute angle with the second jamb surface, the second wedge member forming a second wedge opening that extends along a trajectory that is substantially parallel to the second jamb surface, sliding the linker pin member through the first and second member openings so that the first and second bearing surfaces are on the second surface side of the first member and the second surface side of the second member, respectively, sliding the first wedge member into a securing position between the second surface of the second member and the first bearing surface with the first jamb surface and the first wedge surface adjacent the second surface of the second member and the first bearing surface, respectively, sliding the second wedge member into a securing position between the second surface of the first member and the second bearing surface with the second jamb surface and the second wedge surface adjacent the second surface of the first member and the second bearing surface, respectively, using a first bolt to secure the first wedge member to the linker pin member via the first securing opening, using a second bolt to secure the second wedge member to the linker pin member via the second securing opening and tightening the first and second bolts until the first wedge member is jammed between the second surface of the second member and the first bearing surface and the second wedge member is jammed between the second surface of the first member and the second bearing surface.

Still other embodiments include a fastener assembly for use with first and second members where the first member includes a first surface and the second member includes oppositely facing first and second surfaces and forms a first member opening between the first and second surfaces of the first member and the second member forms a second member opening between the first and second surfaces, the assembly for securing the first member to the second member with the first surface of the first member abutting the first surface of the second member, the assembly comprising a link member secured to the first member and extending from the first surface of the first member, the link member having a first bearing surface and forming a threaded opening and a wedge member forming substantially oppositely facing wedge and jamb surfaces and having a first end and a distal second end, where the wedge surface forms an acute angle with the jamb surface, the wedge member also forming a wedge opening proximate the first end of the wedge member, a bolt having a head member and a threaded shaft that extends from the head member, the shaft passing through the wedge opening, wherein, with the first surface of the first member abutting the first surface of the second member and the link member extending through the first member opening so that the bearing surface is on the second surface side of the second member, the wedge member and bolt are positionable so that the jamb surface is adjacent the second surface of the second member with the bearing surface adjacent the wedge surface and the threaded shaft received in the threaded opening formed by the link member and wherein, when the bolt is rotated to move the head member toward the link member, the bearing surface bears against the wedge surface causing the jamb surface to bear against the second surface of the second member.

In some cases the link member is welded to the first member. In some cases the first member is a hollow tube member and the first surface of the first member is an edge surface of the hollow tube member. In some cases the second member is a second hollow tube member and wherein the first surface of the second member is an exterior surface of a wall member that forms the second hollow tube member. In some cases the first and second members include first and second hollow tube members that are formed by first and second wall members, respectively, wherein the first surface of the first member is an external surface and the first member includes an internal surface and also forms a second member opening and wherein the link member extends through the second member opening and is secured to the second member via a second wedge member and a second bolt.

In some cases the link member includes a formed bracket and a barrel nut where the formed bracket includes an extension member that forms a capture surface that at least in part faces the first surface of the first member, the barrel nut forming the threaded opening for receiving the shaft and forming the bearing surface for bearing against the wedge surface wherein, when the bolt is rotated to move the head member toward the link member, the capture surface bears against a first portion of the bearing surface thereby causing a second portion of the bearing surface to bear against the wedge surface.

Some embodiments further include a compression spring between the nut and the portion of the wedge member adjacent the wedge opening where the threaded shaft passes through the compression spring. In some embodiments the link member includes a pin member that extends from the first member and that forms the threaded opening

Other embodiments include a fastener assembly for use with first and second members, the first member including a first surface and the second member including first and second oppositely facing surfaces where the second member forms a second member opening between the first and second surfaces of the second member, the assembly for securing the first and second members together with the first surface of the first member abutting the first surface of the second member, the assembly comprising a tab member secured to the first member and extending substantially perpendicularly from the first surface of the first member to a distal tab end, the tab forming at least one tab opening adjacent the distal end, a clip member including first and second clip segments that are integrally formed along an intermediate portion, the first clip segment including oppositely facing first and second surfaces and forming a first clip segment opening and the second clip segment including first and second oppositely facing surfaces and forming a second clip segment opening, wherein the second surface of the first clip segment faces the second surface of the second clip segment so that the facing second surfaces form a first clip angle and, wherein, when force is applied between the first surface of the first clip segment and the first surface of the second clip segment, the first and second clip segments are resiliently forced together thereby reducing the first clip angle and a fastener member having a fastener length dimension between first and second ends and forming a first bearing surface at the first end, wherein, with the first surface of the first member abutting the first surface of the second member and the tab member extending through the second member opening, the clip member is positionable so that the first surface of the second clip segment is adjacent the tab, the first and second clip segment openings are aligned with the tab opening and so that the intermediate portion of the clip member is adjacent the second surface of the second member, a portion of the fastener spaced from the bearing surface insertable through the aligned clip member and tab openings and securable to the tab with the clip member compressed between the first bearing surface and the tab member and so that the intermediate portion of the clip member is forced against the second surface of the second member thereby retaining the distal end of the tab member within the first member opening.

In some cases the intermediate portion of the clip member includes a first fold line that bears against the second surface of the second member when the clip member is compressed. In some cases the clip angle is acute.

In some embodiments the fastener member includes a second bearing surface at the second end, the clip member further including third, fourth and fifth clip segments, the third clip segment having first and second ends where the first end is integrally formed with the second clip segment along a second fold line opposite the first fold line, the fourth clip segment is integrally formed with the third clip segment along a third fold line at the second end of the third clip segment and the fifth clip segment is integrally formed with the fourth clip segment along a fourth fold line opposite the third fold line, the fourth clip segment including oppositely facing first and second surfaces and forming a third clip segment opening and the fifth clip segment including first and second oppositely facing surfaces and forming a fourth clip segment opening, wherein the second surface of the fourth clip segment faces the second surface of the fifth clip segment so that the facing second surfaces of the fourth and fifth clip segments form a second clip angle and, wherein, when force is applied between the first surface of the fourth clip segment and the first surface of the fifth clip segment, the fourth and fifth clip segments are resiliently forced together thereby reducing the second clip angle and wherein, with the first surface of the first member abutting the first surface of the second member and the tab member extending through the first member opening, the clip member is positionable so that the tab member is positioned between the first surface of the second clip segment and the first surface of the third clip segment with the tab opening and the first, second, third and fourth clip segment openings aligned and so that the first and fourth fold lines are adjacent the second surface of the second member, wherein the fastener is insertable through the aligned clip member and tab openings and with the first and second clip segments compressed between the first bearing surface and the tab member and the fourth and fifth clip segments compressed between the second bearing surface and the tab member so that the first and fourth fold lines are forced against the second surface of the second member thereby retaining the distal end of the tab member within the first member opening.

In some embodiments when the first and second clip segments are compressed and when the fourth and fifth clip segments are compressed, the second an fourth clip segments are spaced apart from the tab member. In some embodiments the tab member includes a tab bracket that includes first and second substantially parallel arm members spaced apart by a shoulder member that traverses the distance between the arm members and wherein the first arm member forms the first tab opening and the second arm member forms a second tab opening that is aligned with the first tab opening. In some embodiments the tab bracket is formed of steel and is welded to the second member.

In some cases the first member is a tube member having first and second oppositely facing wall members and an end edge, the end edge forming the first surface of the first member, the first and second arm members having distal ends opposite the shoulder member and, wherein, the tab bracket includes a bolt mounted between the first and second substantially parallel arm members, the bolt adjustable to change an expansion dimension between the distal ends of the arm members wherein, with distal ends of the first and second arm members located within the tube and adjacent the first and second wall members, the bolt can be adjusted to force the distal ends of the arm members against the first and second wall members thereby retaining the tab bracket in the end of the tube member adjacent the end edge of the tube member.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1 is a perspective view of a fastener assembly that is consistent with at least some aspects of the present invention where first and second tube members are shown in phantom;

FIG. 2 is an end view of the assembly of FIG. 1;

FIG. 3 is a bottom pan view of the assembly of FIG. 1;

FIG. 4 is a perspective view of a second fastener embodiment that is consistent with at least some aspects of the present invention where first and second tube members are shown in phantom;

FIG. 5 is a perspective view of one of the tube members of FIG. 4;

FIG. 6 is a partial cross sectional view of the fastener of FIG. 4 in two tubes taken along the line 6-6 in FIG. 4;

FIG. 7 is a perspective view of several of the components that form the fastener assembly of FIG. 4;

FIG. 8 is a perspective view of one of the components that form the fastener assembly of FIG. 4;

FIG. 9 is a perspective view of a third fastener assembly that is consistent with at least some aspects of the present invention in an intermediate state where first and second tube members are shown in phantom;

FIG. 10 is similar to FIG. 9, albeit including the fastener assembly in a fastening position;

FIG. 11 is a partial cross sectional view of the assembly of FIG. 10 taken along the line 11-11 in FIG. 10;

FIG. 12 is similar to FIG. 9, albeit showing a fourth inventive fastener assembly;

FIG. 13 is similar to FIG. 10, albeit showing the assembly of FIG. 12 in the fastening position;

FIG. 14 is a similar to FIG. 11, albeit taken along the line 13-13 of FIG. 14; and

FIG. 15 is a perspective view of one of the components of FIG. 12.

### DETAILED DESCRIPTION OF THE INVENTION

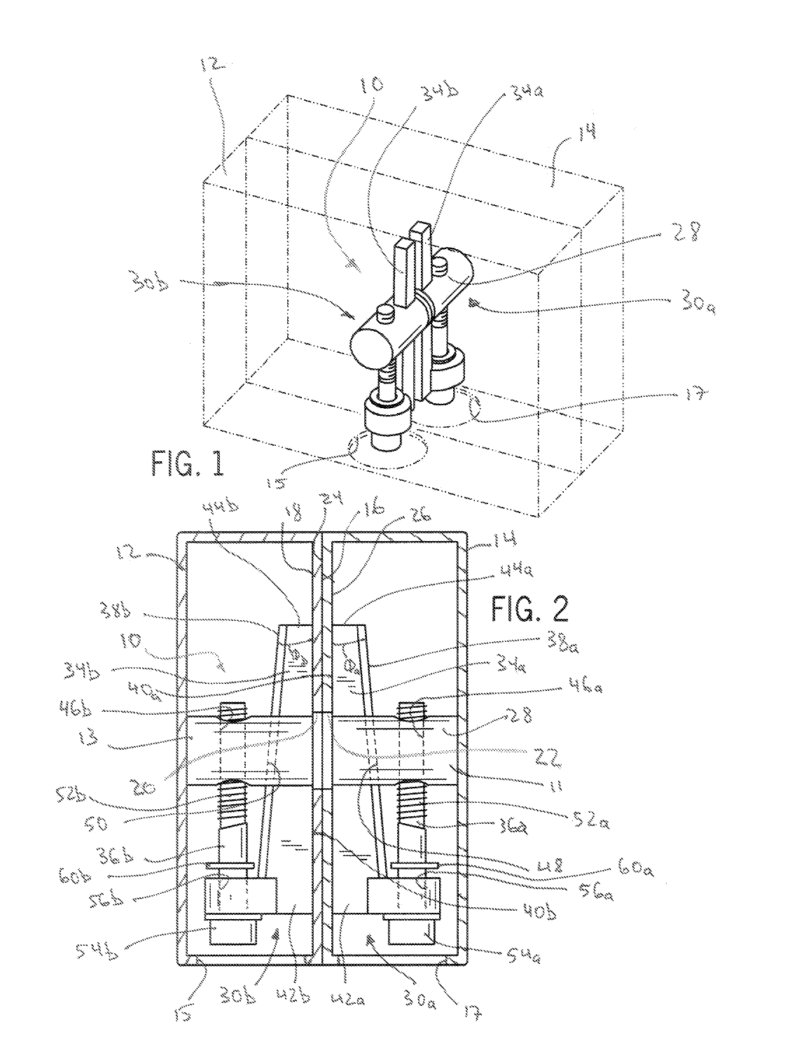

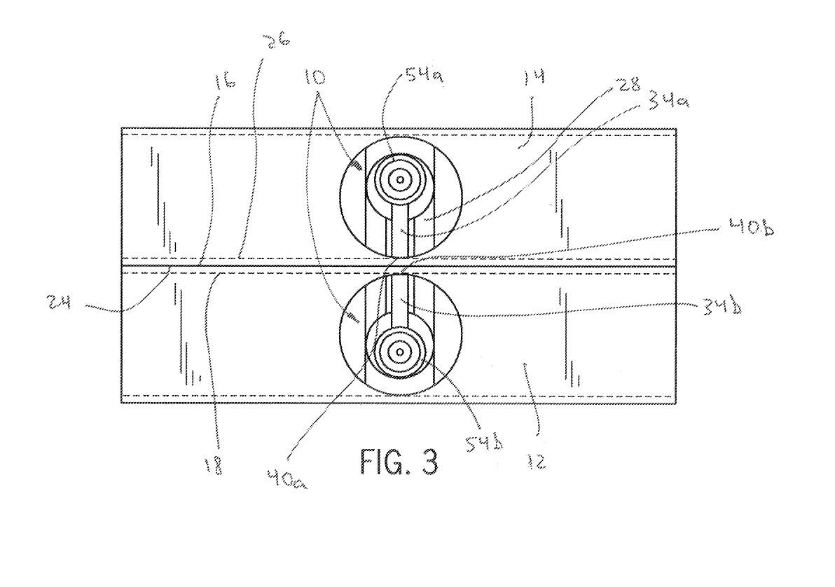

Referring now to the drawings wherein like reference numeral correspond to similar elements throughout the several views and, more specifically, referring to FIGS. 1 through 3, a first fastener assembly 10 is shown in a fastening position securing first and second tube members 12 and 14, respectively, together, in a side by side fashion. Tube 12 is a hollow elongated tube (only a portion shown in phantom in FIG. 1) that includes relatively narrow top and bottom walls and relatively broad first and second side walls (not labeled). The first side wall, also referred to herein as a first member, forms an external first surface 16 and an oppositely facing internal second surface 18 and forms a first member opening 22 (see FIG. 2) between the first and second surfaces. The bottom wall of tube 12 forms an opening 15. Tube 14 is a hollow elongated tube (only a portion shown in phantom in FIG. 1) that includes relatively narrow top and bottom walls and relatively broad first and second side walls (not labeled). The first side wall of second tube 14, also referred to herein as a second member, forms an external first surface 16 and an oppositely facing internal second surface 18 and forms a second member opening 22 (see FIG. 2) between the first and second surfaces. The bottom wall of tube 14 forms an opening 17.

Referring still to FIGS. 1 through 3, fastener assembly 10 includes a linker or pin member 28, a first fastener 30a and a second fastener 30b. Pin member 28 is a cylindrical elongated member having first and second oppositely extending ends 11 and 13, respectively. Pin member 28 forms first and second threaded securing openings 46a and 46b proximate the first and second ends 11 and 13 that are generally perpendicular to the length of pin member 28 and that are formed along substantially parallel trajectories. Between the threaded openings 46a and 46b, pin member 28 forms a central pin opening that includes first and second bearing surfaces 48 and 50, respectively. As shown, in the illustrated embodiment, pin member 28 has a length dimension between the first and second ends 11 and 13 that is substantially equal to the combined width dimension of tube members 12 and 14.

Referring still to FIGS. 1 through 3 and, more specifically, to FIG. 2, the first and second fasteners 30a and 30b, respectively, are similarly constructed and operate in a similar fashion. For this reason, and, in the interest of simplifying this explanation, only fastener 30a will be described here in detail. Here, it should suffice to say that components that are similar between the first and second fasteners will be labeled with identical numbers followed by “a” and “b” qualifiers indicating features and elements associated with the first and second fasteners 30a and 30b, respectively. For example, a bolt associated with first fastener 30a is labeled 36a, while a similar bolt associated with second fastener 30b is labeled 36b.

Referring still to FIG. 2, first fastener 30a includes a first wedge member 34a and a first securing member 36a. The first wedge member 34a, as the label implies, includes a wedge-shaped rigid and elongated structure having a first end 42a and a distal second end 44a. The wedge member 34a forms a wedge surface 38a and a substantially oppositely facing jam surface 44a, each of surfaces 38a and 40a extending substantially the entire length of member 44a between first and second ends 42a and 44a, respectively. Wedge surface 38a and jam surface 40a together define an acute angle φ₁ where surfaces 38a and 40a diverge when moving from second end 44a toward first end 42a. Proximate first end 42a, wedge member 34a forms a first wedge opening 56a about a trajectory that is substantially parallel to jam surface 40a.

Referring to FIGS. 1 through 3, securing member 36a, in the illustrated embodiment, is a bolt having a threaded shaft 52a and a head member 54a. A neck rib 60a extends radially outward from an intermediate position between head member 54a and threaded shaft 52a. Here, the shaft 52a generally extends through the wedge opening 60a with head 54a and neck rib 60a on opposite sides of the portion of wedge member 34a that forms opening 56a so that the bolt 36a is generally secured to wedge member 34a but can still rotate. As illustrated, shaft 36a extends along a trajectory substantially parallel to jam surface 40a formed by wedge member 34a.

To secure tube members 12 and 14 together using assembly 10, referring once again to FIGS. 1 through 3, with members 12 and 14 separated, second end 13 of pin member 28 is inserted through opening 20 formed by member 12 to the point where approximately half of pin member 28 is on either side of opening 20. As shown, once member 28 is properly positioned, bearing surfaces 48 and 50 generally face the first and second surfaces 16 and 18, respectively, formed by member 12. Next, second fastener 30b is aligned with opening 15 so that threaded shaft 36b and the second end 44b of wedge member 42b extend toward threaded opening 46b and the portion of pin opening formed by bearing surfaces 48 and 50 that is located within tube member 12, respectively. Second fastener 30b is slid through opening 15 with second end 44b of wedge member 34b received within pin opening and threaded shaft 52b threadably received within opening 46b. At this point, bolt 36b can be rotated so that shaft 52b becomes loosely secured within opening 46b.

Next, second tube member 14 is aligned with first tube member 12 and pin member 28 such that the first surface 24 of member 14 is facing the first surface 16 of first member 12 and first end 11 of pin member 28 is aligned with opening 22 formed by second tube member 14. Tube member 14 is then moved toward first tube member 12 until the first surfaces 24 and 16 abut. Next, first fastener 30a is aligned with opening 17 and with threaded shaft 52a and the second end 44a of wedge member 34a aligned with threaded opening 46a and the portion of the pin opening located within tube member 14. Second fastener 30a is slid through opening 17 with second end 44a of wedge member 34a received in the pin opening and threaded shaft 52a received within threaded opening 46a.

At this point, an installer can use a tool to rotate heads 54a and 54b thereby causing fasteners 30a and 30b to move further into the spaces formed by tube members 14 and 12, respectively. Eventually, wedge surfaces 38a and 38b of members 34a and 34b bear against the bearing surfaces 48 and 50 formed by the pin opening which in turn causes the jam surfaces 40a and 40b to apply force to second surfaces 26 and 18 of members 14 and 12, respectively, thereby forcing members 14 and 12 together. Eventually, as bolts 36a and 36b are tightened, the wedge members 34a and 34b wedge tube members 14 and 12 together in a tight fit.

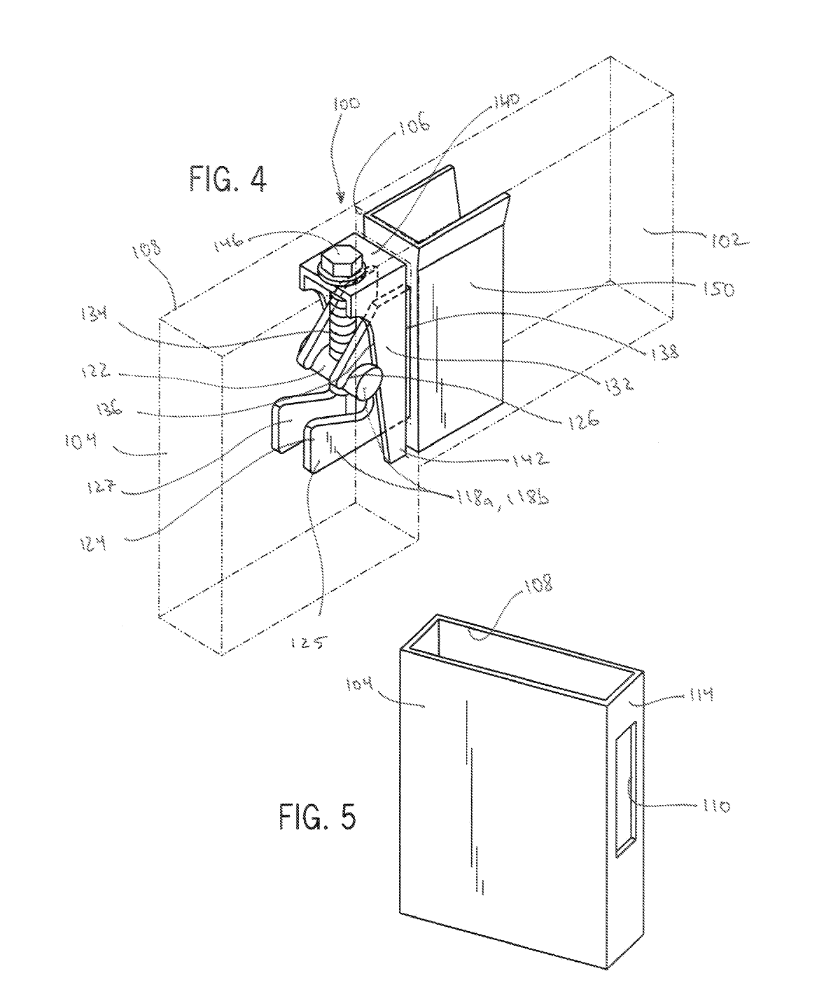

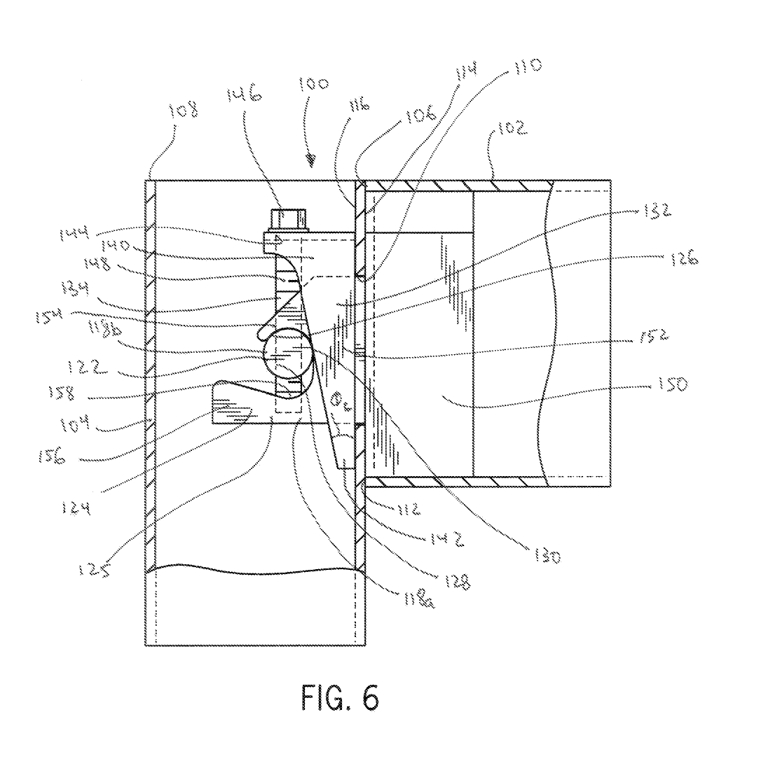

Referring now to FIGS. 4 through 8, a second fastener assembly 100 that is consistent with at least some aspects of the present invention is illustrated. In FIGS. 4 and 6, fastener assembly 100 is shown in the fastening position in which the fastener assembly fastens a first member 102 to a second member 104. In the illustrated embodiment, first member 102 is a first hollow and elongated tube member (only a small portion of the tube is shown) wherein the tube member 102 is open at an end 106 of the tube 102 that is to be connected to tube 104. In cross section, tube member 102 is rectilinear. The edge of open end 106 forms a first member first surface 112 (see FIG. 6).

Second member 104, as illustrated, is a second hollow and elongated tube member that forms an open end 108. Like tube member 102, tube member 104 is rectilinear in cross section. In a sidewall that is to abut first surface 112 of the first tube member 102 when the tubes are connected, second tube member 104 forms an elongated, slot-like opening 110 that opens from a first external surface 114 through to an oppositely facing second or internal surface 116 (see again FIG. 6).

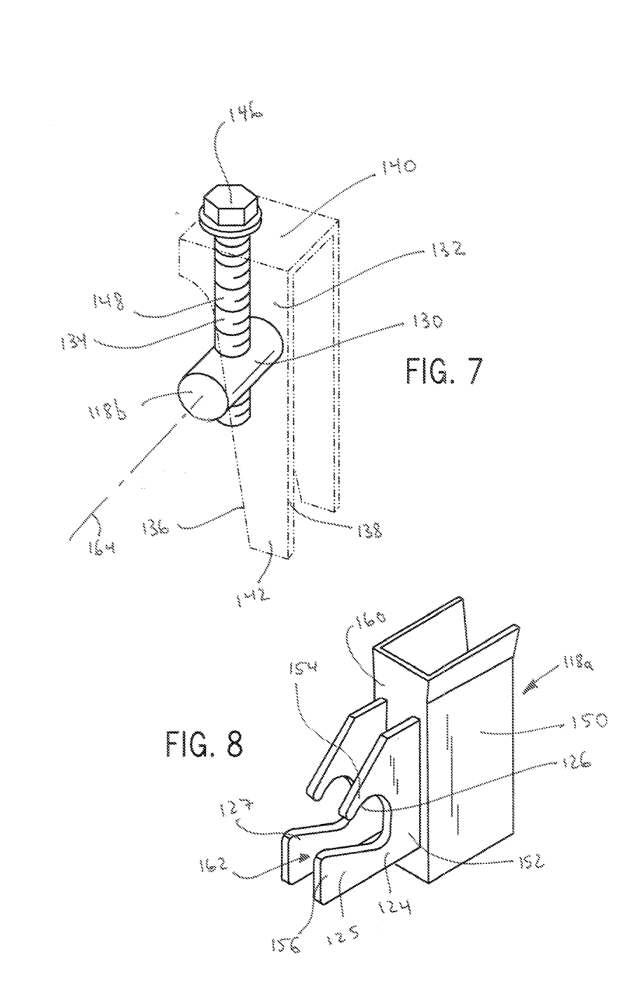

Referring still to FIGS. 4 through 8, fastener assembly 100 includes a two component link member 118a, 118b, a wedge member 132 and a bolt 134. Link member 118a, 118b includes a formed bracket 118a (see FIG. 8) and a barrel nut 118b (see FIG. 7). Formed bracket 120 includes an anchor member 150 and an extension member 124. Anchor member 150, as the label implies, includes a bent metal clip that is receivable within the open end 106 of first member 102 and that can be welded therein to anchor the formed bracket at the open end 106. Extension member 124 includes two similarly shaped extension members that extend from anchor member 150. Extension member 124 includes first and second barrel nut retainer members 125 and 127, respectively. Each of the retainer members 125 and 127 is similarly constructed and operates in a similar fashion and therefore, in the interest of simplifying this explanation, only retainer member 125 will be described here in detail.

Referring specifically to FIGS. 6 and 8, retainer member 125 is a flat rigid member that includes a base portion 152, a finger member 154 and a thumb member 156. The base portion 152 is a substantially rectilinear member having first and second ends and first and second oppositely facing elongated lateral edges where a second of the lateral edges is permanently attached (e.g., welded) to anchor member 150. Finger member 154 is integrally formed with base portion 152 and extends from the first lateral edge thereof away from anchor member 150 and curls back at a distal end to form a capture surface 126 that generally faces the second end of base member 152. Thumb member 156 extends from the second end of base member 152 generally in the same direction that finger member 154 extends but is spaced apart therefrom so that a substantially C-shaped channel 158 is formed by the generally facing edge surfaces of finger member 154 and thumb member 156.

All of the base portion 152, finger member 154 and thumb member 156 are generally coplanar. Referring still to FIG. 8, first and second retainer members 125, 127 are permanently secured to an end surface 160 of anchor member 150 and extend substantially perpendicularly therefrom. As shown, retainer members 125 and 127 are parallel and are spaced apart so as to form a channel 162 therebetween. In at least some embodiments formed bracket 118a is made of bent steel sheet components.

Referring again to FIGS. 4, 6 and 7, barrel nut 118b is a cylindrical pin member formed around a nut axis 164. Nut 118b includes an external bearing surface 130 and forms a threaded opening 128 that extends through the bearing surface 130 along the trajectory that is substantially perpendicular to nut axis 164. Opening 128 is formed approximately mid-way between oppositely extending ends of nut 118b. Nut 118b has a diameter dimension such that, as best shown in FIG. 6, nut 118b is receivable on the capture surface 126 formed by finger member 154.

Referring still to FIGS. 4, 6 and 7, bolt 134 includes a threaded shaft 148 and a head member 146. Shaft 148 is sized and threaded such that it is threadably receivable within the threaded opening 128 formed by nut 118b.

Wedge member 132 is similar to wedge member 34 described above. To this end, wedge member 132 is a rigid elongated member having first and second ends 140 and 142 that forms substantially oppositely facing wedge and jamb surfaces 136 and 138, respectively. The wedge and jamb surfaces 136 and 138 extend substantially along the entire length of wedge member 132 between first and second ends 140 and 142, respectively, and form an acute angle φ_{c} therebetween such that the wedge and jamb surfaces 136 and 138, respectively, diverge when moving from the second end 142 toward the first end 140. At the first end 140, wedge member 132 forms a wedge opening 144 dimensioned to pass the threaded shaft 148 of bolt 134. In at least some embodiments wedge member 132 is formed of bent steel sheet.

Referring again to FIGS. 4 through 8, to use assembly 100 to secure tube member 102 and 104 together, with formed bracket 118a secured at the open end 106 of member 102 so that retainer members 125 and 127 extend outwardly therefrom, side wall opening 110 of member 104 (see specifically FIG. 5) is aligned with retainer member 125 and 127. Member 104 is moved toward member 102 until first surface 114 of member 104 abuts first surface 106 of member 102 (see specifically FIG. 6). Next, shaft 148 of bolt 134 is passed through wedge opening 144 and the distal end thereof is received in threaded opening 128 so that nut 118b is attached to the distal end of bolt 134. The subassembly including wedge member 132, bolt 134 and nut 118b is aligned with the open end 108 of member 104 so that second end 142 of wedge member 132 and the distal end of bolt 134 are directed toward open end 108. The subassembly including member 132, bolt 134 and nut 118b is then slid into opening 108 and is generally moved toward tube member 102 until shaft 148 of bolt 134 is received within channel 162 and nut 118b is received within the C-shaped channel 158 defined by retainer members 125 and 127 as best shown in FIG. 6. Continuing, bolt 146 is rotated thereby causing nut 118b to move toward head member 146. As nut 118b moves toward head member 146, the bearing surface 130 formed by nut 118b is pressed against capture surface 126 which in turn forces a different portion of the bearing surface 130 to abut and press against wedge surface 136. As bolt 134 is tightened, wedge member 132 becomes wedged between the bearing surface 130 and the second or internal surface 116 of tube member 104 thereby drawing tube member 102 into a tight fit engagement with tube member 104. Although not illustrated, and end cap or the like may be press fit into the open end 108 of tube 104 to completely conceal fastener assembly 100.

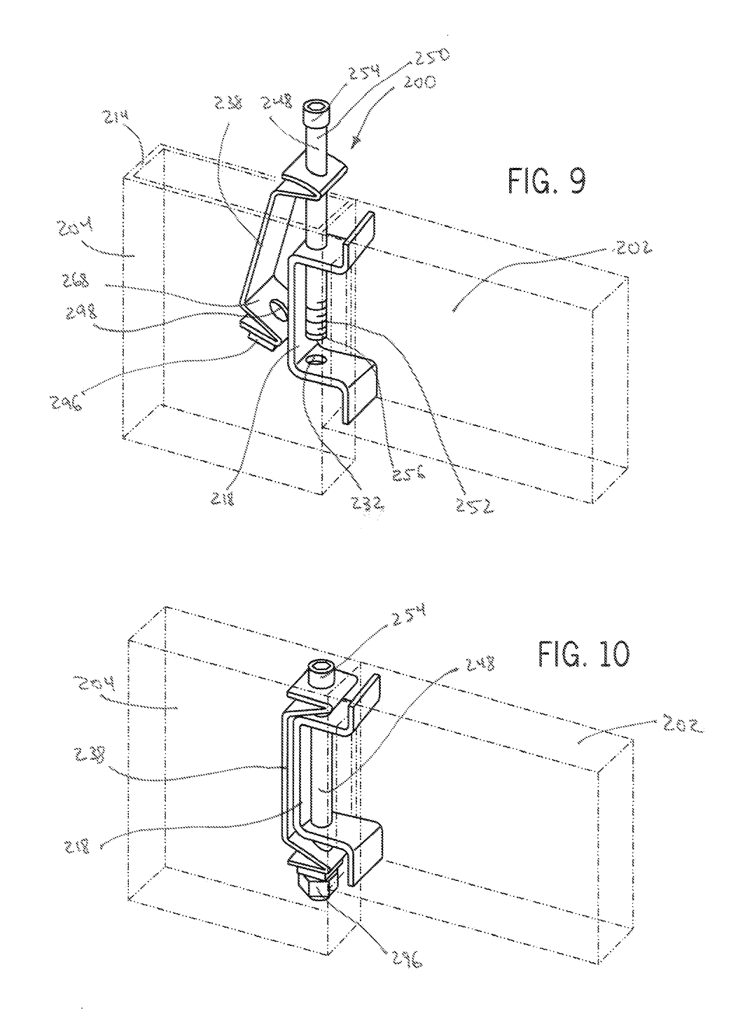

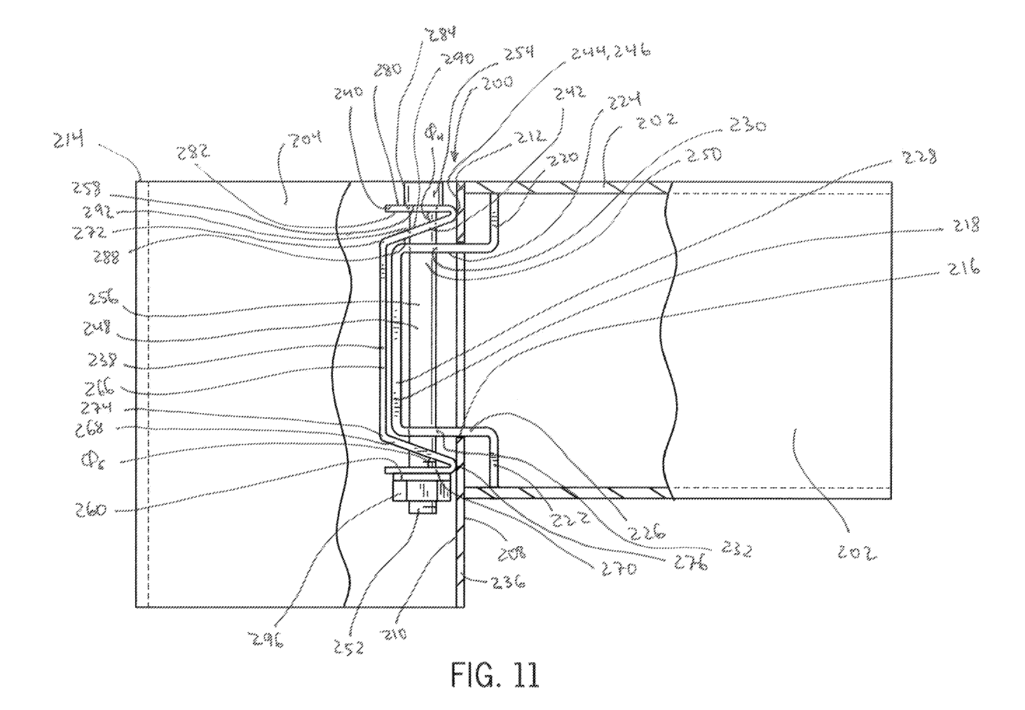

Referring now to FIGS. 9 through 11, a third fastener assembly 200 that is consistent with at least some aspects of the present invention is illustrated. In FIG. 9, the fastener assembly 200 is shown in a state prior to fastening while in FIGS. 10 and 11 the fastener assembly 200 is shown in a fastened position wherein the assembly 200 fastens a first member 202 to a second member 204.

In the illustrated embodiment, members 202 and 204 are each elongated and hollow tube members (only ends of the tube members are shown) that, in cross-section, have rectilinear shapes. Tube member 202 has an open end 212 and the edge of tube 202 forms a first surface (also referred to via numeral 212). Second member 204 also includes an open end 214 and has a flat end wall member 236 that forms oppositely facing first and second surfaces 208 and 210, respectively (see FIG. 11). Wall 236 forms a second member opening 216 that opens between the first and second surfaces 208 and 210, respectively.

Referring still to FIGS. 9 through 11, fastener assembly 200 includes a tab member or bracket 218, a clip member 238 and a fastener member in the form of a bolt 248 and a nut 296. Tab member or bracket 218 is a rigid bent sheet metal bracket including a first anchor segment 220, a second anchor segment 222, a first arm member or segment 224, a second arm member or segment 226 and a shoulder member or segment 228. Shoulder segment 228 is an elongated, rigid and rectilinear member that has first and second ends. First arm segment 224 is secured to a first end of should segment 228 and extends to one side thereof and substantially perpendicular thereto. Second arm segment 226 extends from the second end of shoulder segment 228 in the same direction that segment 224 extends and is substantially parallel to first segment 224. First anchor segment 220 extends from an edge of first arm segment 224 opposite shoulder segment 228, is substantially perpendicular to arm segment 224 and extends in a direction from segment 224 opposite the direction in which shoulder segment 228 extends. Similarly, second anchor segment 222 extends from an edge of second arm segment 226 opposite shoulder segment 228, is substantially perpendicular segment 226 and extends in a direction from arm segment 226 opposite the direction in which segment 228 extends from segment 226. The anchor segments 220 and 222 in the illustrated embodiment are coplanar and each has a length dimension (i.e., the dimension between the edge connected to an adjacent arm member and a distal edge) that is approximately 1/3 the length of shoulder member 228 between the first and second ends thereof. Overall, the combined length of the anchor members 220 and 222 and shoulder member 228 is similar to a length dimension defined by facing internal surfaces of tube member 202. Referring specifically to FIG. 11, the arm segments 224 and 226 form first and second tab openings 230 and 232, respectively, adjacent shoulder segment 228, where the openings 230 and 232 are aligned along a trajectory that is substantially parallel to shoulder segment 228.

Referring still to FIG. 11, tab bracket 218 is permanently secured within an adjacent open end 112 of tube member 202 such that arm segments 224 and 226 extend out and past the open end 212 of member 202. When properly mounted within open end 212, shoulder segment 228 is spaced from edge 212 as are tab openings 230 and 232. Bracket 218 may be secured within open end 212 in any manner known in the industry and, in at least some embodiments, may be secured there via welding.

Referring once again to FIGS. 9 through 11, clip member 238 is a bent steel sheet metal strip member and includes a first clip segment 240, a second clip segment 242, a third clip segment 266, a fourth clip segment 268 and a fifth segment 270. All of the first through fifth clip segments are integrally formed together and each of the first through fifth clip segments is generally square or rectilinear when viewed independently in plan view. In addition, each of the first, second, fourth and fifth clip segments includes first and second oppositely facing surfaces and each forms a clip segment opening. For example, first clip segment 240 includes first and second oppositely facing surfaces 280 and 282, respectively, and forms a first clip segment opening 284 (see FIG. 11). Similarly, second clip segment 242 includes first and second oppositely facing surfaces 288 and 290, respectively, and a second clip segment opening 292.

Referring to FIG. 9, fourth clip segment 268 forms third clip segment opening 298. Although not labeled, it should be appreciated that fourth clip segment 268 and fifth clip segment 270 each includes first and second oppositely facing surfaces and that fifth clip segment 270 forms a fourth clip segment opening through which a shaft 252 of bolt 248 passes. A cage nut 296 is mounted to the first surface of fifth clip segment 270 and is aligned with the fourth clip segment opening. In FIG. 11, the facing surfaces of fourth clip segment 268 and fifth clip segment 270 are the second surfaces of those segments.

Referring yet again to FIGS. 9 through 11, first clip segment 240 is connected to second clip segment 242 along a first fold line 246 where the fold line 246 is also referred to as an intermediate segment or portion 244. Third clip segment 266 is connected to second clip segment 242 along a second fold line 272 along an edge opposite the edge to which first clip segment 240 is connected. Fourth clip segment 268 is connected along a third fold line 274 to third clip segment 266 opposite the end of third clip segment 266 to which second segment 242 is connected. Fifth clip segment 270 is connected to fourth clip segment 268 along a fourth fold line 276 opposite the edge of fourth clip segment 268 to which third clip segment 266 is connected. When properly formed, the second surfaces 282 and 290 of the first and second clip segments 240 and 242, respectively, face each other and form an acute angle φ₄. Similarly, the second surfaces of fourth and fifth clip segments 268 and 270 face each other and form an acute angle φ₅ that is similar to angle φ₄. Third clip segment 266 forms obtuse angles with each of segments 242 and 268.

Referring again to FIGS. 9 through 11, fastener member or bolt 248 is an elongated member having first and second ends 250a and 252, respectively, and having a head member 254 at the first end 250 and a threaded shaft 256 that extends from the head member 254 to the second end 252. Shaft 256 is dimensioned so that it will fit through the openings 230 and 232 formed by tab bracket 218 as well as through the clip segment openings formed by the first, second, fourth and fifth clip segments 240, 242, 268 and 270, respectively. The undersurface of head member 254 adjacent shaft 256 forms a first bearing surface 258. Cage nut 296 forms a threaded opening for threadably receiving the distal end of shaft 256 and forms a second bearing surface 260. Here, the cage nut 296 is retained just below the fourth clip segment opening formed by fifth clip segment 270 and is aligned therewith so that when shaft 256 passes through the opening formed by clip segment 270, the distal end of shaft 256 is aligned with the nut 296 opening.

Referring again to FIGS. 9 through 11, to secure first tube member 202 to second tube member 204, first, tab bracket 218 is secured within and adjacent open end 212 of member 202. Next, opening 216 formed by second tube member 204 is aligned with tab member 218. Member 204 is moved toward member 202 until first surface 208 of member 204 abuts first surface 212 of member 202.

Referring specifically to FIG. 9, shaft 256 is threaded through the first and second clip segment openings 284 and 292. Clip member 238 is bent away from shaft 256 as shown in FIG. 9 and shaft 256 is aligned with the first and second tab openings 230 and 232, respectively. Bolt 248 is moved downward into the open end 214 of second tube member 204 until the distal end of shaft 256 passes through both tab openings 230 and 232. Next, third clip segment 266 of clip member 238 is forced toward shoulder segment 228 of tab bracket 218 until the clip segment openings formed by the fourth and fifth clip segments 268 and 270, respectively, are aligned with second tab opening 232. The distal end of shaft 256 is forced through the openings formed by fourth and fifth clip segments 268 and 270, respectively, and bolt 248 is rotated so that the distal end of shaft 256 is threadably received within cage nut 296.

Referring specifically to FIG. 11, as bolt 248 is rotated, the first bearing surface 258 formed by head member 254 and the second bearing surface 260 formed by nut 296 abut the first surfaces of first clip segment 240 and fifth clip segment 270 thereby compressing the clip member 238. As the bolt 248 is tightened, the intermediate portions of the clip member 238 that form the first and fourth fold lines 246 and 276 are forced against the second surface 210 of the second tube member 204 thereby drawing the first tube member 202 and the second tube member 204 together in a tight fit manner.

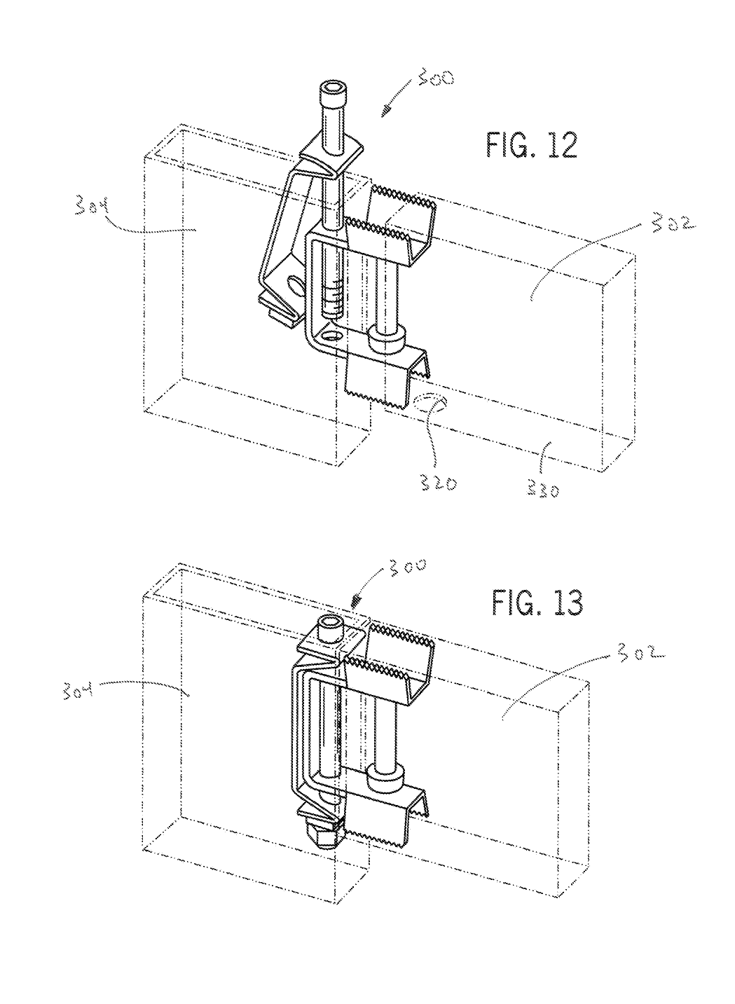

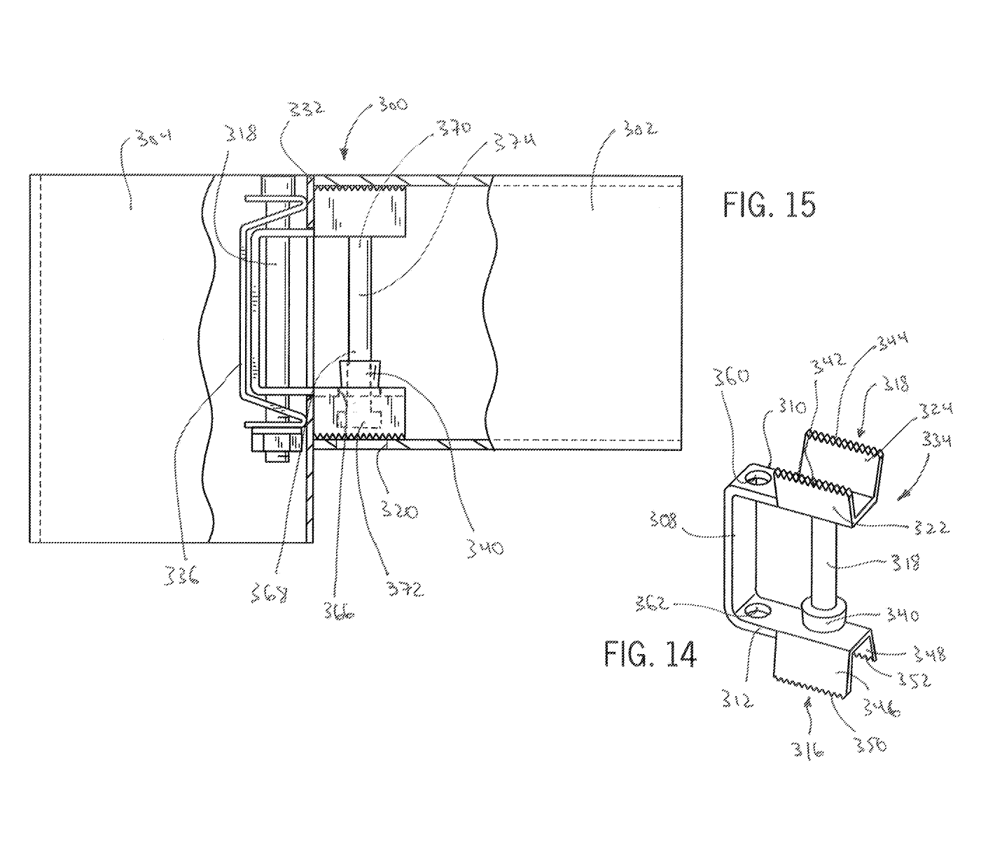

Referring now to FIGS. 12 through 14, a fourth fastener assembly 300 is illustrated for fastening together first and second tube members 302 and 304, respectively. Here, the first and second tube member 302 and 304 are similar to the tube members described above with respect to FIGS. 9 through 11 and therefore will not again be described here in detail. The only difference between tube member 302 and tube member 202 described above is that tube member 302 forms an anchor opening 320 in a bottom wall 330 proximate an open end 332 of member 302. The anchor opening 320 is used to access a tab bracket shown in FIG. 14 and described in greater detail below.

Fastener assembly 300 includes tab bracket 334 as well as clip member 336, bolt 338 and cage nut 340. Here, the clip member 336, bolt 338 and cage nut 340 are substantially similar and operate in a similar fashion to clip member 238, bolt 248 and nut 296 described above with respect to FIGS. 9 through 11 and therefore, in the interest of simplifying this explanation, those member will not again be described here in detail.

Referring specifically to FIG. 14, tab bracket 334 includes a shoulder segment 208, first and second arm segments 310 and 312, a first anchor foot 314, a second anchor foot 316, a bolt 318 and a cage nut 340. Shoulder segment 308 and first and second arm segments 310 and 312 are similar to, and operate in a similar fashion to, shoulder segment 228 and first and second arm segments 224 and 226 described above with respect to FIGS. 9 through 11 and therefore, in the interest of simplifying this explanation, those components will not be again described here in detail.

Referring still to FIG. 14, first anchor foot 314 includes first and second finger member 322 and 324 that extend from opposite edges of first arm segment 310 so that segment 310 and members 322 and 324 together define a U-shaped configuration where distal edges 342 and 344 of finger members 322 and 324 are spaced apart and generally face away from second arm segment 312. In at least some embodiments distal edges 342 and 344 are serrated to increase frictional forces between those edges and the internal surface of tube member 402. Similarly, second anchor foot 316 includes first and second finger member 346 and 348 that extend from opposite edges of second arm segment 312 where distal edges 350 and 352 of finger members 346 and 348 are spaced apart and generally face in the direction away from first arm segment 310.

First arm segment 310 forms a first tab opening 360 while second arm member 312 forms a second tab opening 362 that is aligned with first tab opening 360. In addition to forming second tab opening 362, referring to FIG. 15, second arm segment 312 forms another opening 366 proximate second anchor foot 316 for passing the shaft of bolt 318. Cage nut 340 is mounted to the surface of second arm member 312 that faces first arm member 310 and is aligned with opening 366.

Referring still to FIGS. 12 through 15, bolt 338 is an elongated bolt having first and second ends 368 and 370, respectively, where the bolt includes a head member 372 shown in phantom in FIG. 15 and a threaded shaft 374 that extends from head member 372 to the second end 370. Bolt shaft 374 is fed between finger members 346 and 348 and through opening 366 and is threadably received within cage nut 340 until second end 370 of bolt 338 contacts the surface of first arm segment 310 that faces second arm segment 312. Here, bolt 338 should be adjusted such that the dimension between oppositely facing edges 342 and 344 and edges 350 and 352 is less than the dimension formed by the facing internal surfaces of tube member 302.

To install tab bracket 334 in the open end 332 of first tube member 302, the first and second anchor feet 314 and 316 are aligned with the open end 332 and are slid into end 332 until head member 372 is aligned with anchor opening 320 as seen in FIG. 15. Next, bolt 338 is rotated to extend the portion of bolt 338 between first and second arm segments 310 and 312. As the bolt 338 is rotated, the distal edges 342, 344, 350 and 352 are forced against the internal surfaces of tube member 302 thereby fastening tab bracket 334 at the open end 332. After bracket 334 has been installed in open end 332, the other assembly components including bolt 318 and clip member 336 are installed as described above to secure first and second tube member 302 and 304, respectively, together.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, referring again to FIGS. 1 through 3, while the first assembly 10 is described above as including first and second fasteners that are used to secure first and second tube members together, it should be appreciated that, in at least some embodiments, a single fastener may be used in conjunction with a different type of linker or pin member to secure any two components together. For example, referring again to FIG. 2, linker or pin member 28 may be replaced by a pin member similar to the one illustrated, albeit including a stop surface in place of jamb surface 40b where the stop surface is integrally formed with or securely attached to pin member 28. Here, single fastener 30a may be employed with the modified pin member to secure two tubes together or to secure any other two components wherein each of the components includes first and second oppositely facing surfaces and forms an opening for the pin member to extend through.

In addition, other embodiments described above may be employed to secure other than tube members together. For example, referring again to FIGS. 4 through 6, where retainer members 125 and 127 extend from a wall surface, a wedge member, barrel nut and bolt akin to wedge member 132, nut 118b and bolt 134 may be used to secure a member to the wall surface in a manner similar to that shown. Moreover, fasteners other than bolts may be includes in some embodiments.

To apprise the public of the scope of this invention, the following claims are made:

What is claimed is:

1. A fastener assembly for use with first and second members that each include first and second oppositely facing surfaces where the first member forms a first member opening between the first and second surfaces of the first member and the second member forms a second member opening between the first and second surfaces of the second member, the assembly for securing the first member to the second member with the first surface of the first member abutting the first surface of the second member, the assembly comprising:
a linker having a linker length dimension between first and second ends and having a first bearing surface and a substantially oppositely facing first stop surface that are substantially perpendicular to the linker length dimension; and
a fastener including a wedge member and a securing member, the wedge member forming substantially oppositely facing wedge and jamb surfaces and having a first end and a distal second end, where the wedge surface forms an acute angle with the jamb surface, the securing member extending from the first end of the wedge member and substantially parallel to the jamb surface and configured to engage the linker;
wherein, with the first surface of the first member abutting the first surface of the second member and the first and second member openings substantially aligned, the linker is positionable to extend through the first and second member openings with the first stop surface abutting the second surface of the first member and the first bearing surface on the second surface side of the second member, the fastener positionable so that the wedge member is jammed in a securing position between the second surface of the second member and the bearing surface with the jamb surface and the wedge surface abutting the second surface of the second member and the bearing surface, respectively, and with the securing member engaged to the linker to maintain the wedge member in the securing position.

2. The assembly of claim 1 wherein the linker forms a threaded securing opening and wherein the securing member includes a bolt including a head member and a threaded shaft that is receivable within the securing opening to secure the fastener to the linker.

3. The assembly of claim 2 wherein the wedge member forms a wedge opening and wherein the threaded shaft of the bolt extends through the wedge opening toward the threaded opening formed by the linker.

4. The assembly of claim 3 wherein each of the wedge surface and the jamb surface are substantially flat.

5. The assembly of claim 1 wherein at least the second member is a tube member and wherein the first and second surfaces of the second member include substantially flat external and internal surfaces of the tube member, respectively.

6. The assembly of claim 5 wherein the first member is also a tube member and wherein the first and second surfaces of the first member include substantially flat external and internal surfaces of the tube member, respectively.

7. The assembly of claim 1 wherein the linker includes a pin member that forms a pin opening for at least in part receiving the wedge member where the pin opening forms the bearing surface.

8. The assembly of claim 7 wherein the pin member is a cylindrical member.

9. The assembly of claim 7 wherein the pin member also forms a threaded securing opening and wherein the securing member includes a bolt including a head member and a threaded shaft that is receivable within the securing opening to secure the fastener to the linker.

10. The assembly of claim 1 wherein the fastener, the wedge member, the securing member, the wedge surface, the jamb surface and the bearing surface are a first fastener, a first wedge member, a first securing member, a first wedge surface, a first jamb surface and a first bearing surface, respectively, and, wherein, the linker forms a second bearing surface that faces a direction substantially opposite the first bearing surface, the linker including a second fastener, the second fastener including a second wedge member and a second securing member, the second wedge member forming substantially oppositely facing second wedge and second jamb surfaces and having a first end and a distal second end, where the second wedge surface forms an acute angle with the second jamb surface and the second jamb surface forms the stop surface, the second securing member extending from the first end of the second wedge member and substantially parallel to the second jamb surface and configured to engage the linker, and, wherein, when the linker extends through the first and second member openings, the first and second bearing surfaces are on the second surface side of the second member and the second surface side of the first member, respectively, the second fastener positionable so that the second wedge member is jammed in a securing position between the second surface of the first member and the second bearing surface with the second jamb surface and the second wedge surface abutting the second surface of the first member and the second bearing surface, respectively, and with the second securing member engaged to the linker to maintain the second wedge member in the securing position.

11. The assembly of claim 10 wherein the linker includes a pin member that forms at least a first pin opening for at least in part receiving the first and second wedge members where the pin opening forms the first and second bearing surfaces and wherein at least a portion of each of the first and second wedge members extends through the pin opening when the first and second wedge members are in the securing positions.

12. The assembly of claim 11 wherein the pin member also forms first and second threaded securing openings and wherein the first and second securing members include first and second bolts including head members and a threaded shafts that are receivable within the first and second securing openings to secure the first and second fasteners to the linker, respectively.

13. The assembly of claim 12 wherein the first and second wedge members form first and second wedge openings proximate the first ends of the first and second wedge members for passing the threaded shafts, the assembly further including first and second retainers that extend from portions of the threaded shafts adjacent the first and second wedge openings to retain the first and second bolts to the first and second wedge members, respectively.

14. The assembly of claim 10 wherein the first and second members include first and second tube members and wherein the first and second surfaces of the first member include substantially flat external and internal surfaces of the first tube member, respectively, and, the first and second surfaces of the second member include substantially flat external and internal surfaces of the second tube member, respectively.

15. The assembly of claim 14 wherein the first and second threaded securing openings extend along substantially parallel trajectories.

16. A fastener assembly for use with first and second members that each include first and second oppositely facing surfaces where the first member forms a first member opening between the first and second surfaces of the first member and the second member forms a second member opening between the first and second surfaces of the second member, the assembly for securing the first member to the second member with the first surface of the first member abutting the first surface of the second member, the assembly comprising:
a linker pin member having a linker length dimension between first and second ends and forming first and second threaded and substantially parallel securing openings proximate the first and second ends, respectively, the linker pin also forming at least a first pin opening located between the first and second securing openings where the pin opening forms first and second oppositely facing bearing surfaces proximate the first and second securing openings, respectively;
a first wedge member forming substantially oppositely facing first wedge and first jamb surfaces and having a first end and a distal second end, the first wedge surface forming an acute angle with the first jamb surface, the first wedge member forming a first wedge opening that extends along a trajectory that is substantially parallel to the first jamb surface;
a second wedge member forming substantially oppositely facing second wedge and second jamb surfaces and having a first end and a distal second end, the second wedge surface forming an acute angle with the second jamb surface, the second wedge member forming a second wedge opening that extends along a trajectory that is substantially parallel to the second jamb surface;
a first bolt having a first head member and a first threaded shaft that extends from the first head member;
a second bolt having a second head member and a second threaded shaft that extends from the second head member;
wherein, with the first surface of the first member abutting the first surface of the second member and the first and second member openings substantially aligned, the linker pin member is positionable to extend through the first and second member openings with the first and second bearing surfaces on the second surface side of the second member and the second surface side of the first member, respectively, the first wedge member positionable in a securing position between the second surface of the second member and the first bearing surface with the first jamb surface and the first wedge surface abutting the second surface of the second member and the first bearing surface, respectively, the second wedge member positionable in a securing position between the second surface of the first member and the second bearing surface with the second jamb surface and the second wedge surface abutting the second surface of the first member and the second bearing surface, respectively; and
wherein, the first threaded shaft is positionable to pass through the first wedge opening and is receivable within the first threaded securing opening formed by the linker pin member to secure the first wedge member in the securing position and the second threaded shaft is positionable to pass through the second wedge opening and is receivable within the second threaded securing opening formed by the linker pin member to secure the second wedge member in the securing position.

17. The assembly of claim 16 wherein each of the wedge surfaces and the jamb surfaces is substantially flat.

18. The assembly of claim 16 wherein the first and second members include first and second tube members and wherein the first and second surfaces of the first member include substantially flat external and internal surfaces of the first tube member, respectively, and, the first and second surfaces of the second member include substantially flat external and internal surfaces of the second tube member, respectively.

19. The assembly of claim 16 wherein the linker pin member is a cylindrical member.

20. A method for use with first and second members that each include first and second oppositely facing surfaces where the first member forms a first member opening between the first and second surfaces of the first member and the second member forms a second member opening between the first and second surfaces of the second member, the method for securing the first member to the second member with the first surface of the first member abutting the first surface of the second member, the method comprising the steps of:
providing a linker pin member having a linker length dimension between first and second ends and forming first and second threaded and substantially parallel securing openings proximate the first and second ends, respectively, the linker pin also forming at least a first pin opening located between the first and second securing openings where the pin opening forms first and second oppositely facing bearing surfaces proximate the first and second securing openings, respectively;
providing a first wedge member forming substantially oppositely facing first wedge and first jamb surfaces and having a first end and a distal second end, the first wedge surface forming an acute angle with the first jamb surface, the first wedge member forming a first wedge opening that extends along a trajectory that is substantially parallel to the first jamb surface;
providing a second wedge member forming substantially oppositely facing second wedge and second jamb surfaces and having a first end and a distal second end, the second wedge surface forming an acute angle with the second jamb surface, the second wedge member forming a second wedge opening that extends along a trajectory that is substantially parallel to the second jamb surface;
sliding the linker pin member through the first and second member openings so that the first and second bearing surfaces are on the second surface side of the first member and the second surface side of the second member, respectively;
sliding the first wedge member into a securing position between the second surface of the second member and the first bearing surface with the first jamb surface and the first wedge surface adjacent the second surface of the second member and the first bearing surface, respectively;
sliding the second wedge member into a securing position between the second surface of the first member and the second bearing surface with the second jamb surface and the second wedge surface adjacent the second surface of the first member and the second bearing surface, respectively;
using a first bolt to secure the first wedge member to the linker pin member via the first securing opening;
using a second bolt to secure the second wedge member to the linker pin member via the second securing opening; and
tightening the first and second bolts until the first wedge member is jammed between the second surface of the second member and the first bearing surface and the second wedge member is jammed between the second surface of the first member and the second bearing surface.

21. A fastener assembly for use with first and second members where the first member includes a first surface and the second member includes oppositely facing first and second surfaces and forms a first member opening between the first and second surfaces of the first member and the second member forms a second member opening between the first and second surfaces, the assembly for securing the first member to the second member with the first surface of the first member abutting the first surface of the second member, the assembly comprising:
a link member secured to the first member and extending from the first surface of the first member, the link member having a first bearing surface and forming a threaded opening; and
a wedge member forming substantially oppositely facing wedge and jamb surfaces and having a first end and a distal second end, where the wedge surface forms an acute angle with the jamb surface, the wedge member also forming a wedge opening proximate the first end of the wedge member;
a bolt having a head member and a threaded shaft that extends from the head member, the shaft passing through the wedge opening;
wherein, with the first surface of the first member abutting the first surface of the second member and the link member extending through the first member opening so that the bearing surface is on the second surface side of the second member, the wedge member and bolt are positionable so that the jamb surface is adjacent the second surface of the second member with the bearing surface adjacent the wedge surface and the threaded shaft received in the threaded opening formed by the link member; and
wherein, when the bolt is rotated to move the head member toward the link member, the bearing surface bears against the wedge surface causing the jamb surface to bear against the second surface of the second member.

22. The assembly of claim 21 wherein the link member is welded to the first member.

23. The assembly of claim 21 wherein the first member is a hollow tube member and the first surface of the first member is an edge surface of the hollow tube member.

24. The assembly of claim 23 wherein the second member is a second hollow tube member and wherein the first surface of the second member is an exterior surface of a wall member that forms the second hollow tube member.

25. The assembly of claim 21 wherein the first and second members include first and second hollow tube members that are formed by first and second wall members, respectively, wherein the first surface of the first member is an external surface and the first member includes an internal surface and also forms a second member opening and wherein the link member extends through the second member opening and is secured to the second member via a second wedge member and a second bolt.

26. The assembly of claim 21 wherein the link member includes a formed bracket and a barrel nut where the formed bracket includes an extension member that forms a capture surface that at least in part faces the first surface of the first member, the barrel nut forming the threaded opening for receiving the shaft and forming the bearing surface for bearing against the wedge surface wherein, when the bolt is rotated to move the head member toward the link member, the capture surface bears against a first portion of the bearing surface thereby causing a second portion of the bearing surface to bear against the wedge surface.

27. The assembly of claim 26 further including a compression spring between the nut and the portion of the wedge member adjacent the wedge opening where the threaded shaft passes through the compression spring.

28. The assembly of claim 21 wherein the link member includes a pin member that extends from the first member and that forms the threaded opening.

29. A fastener assembly for use with first and second members, the first member including a first surface and the second member including first and second oppositely facing surfaces where the first member forms a first member opening between the first and second surfaces of the first member, the assembly for securing the first and second members together with the first surface of the first member abutting the first surface of the second member, the assembly comprising:
a tab member secured to the first member and extending substantially perpendicularly from the first surface of the first member to a distal tab end, the tab forming at least one tab opening adjacent the distal end;
a clip member including first and second clip segments that are integrally formed along an intermediate portion, the first clip segment including oppositely facing first and second surfaces and forming a first clip segment opening and the second clip segment including first and second oppositely facing surfaces and forming a second clip segment opening, wherein the second surface of the first clip segment faces the second surface of the second clip segment so that the facing second surfaces form a first clip angle and, wherein, when force is applied between the first surface of the first clip segment and the first surface of the second clip segment, the first and second clip segments are resiliently forced together thereby reducing the first clip angle; and
a fastener member having a fastener length dimension between first and second ends and forming a first bearing surface at the first end;
wherein, with the first surface of the first member abutting the first surface of the second member and the tab member extending through the first member opening, the clip member is positionable so that the first surface of the second clip segment is adjacent the tab, the first and second clip segment openings are aligned with the tab opening and so that the intermediate portion of the clip member is adjacent the second surface of the second member, a portion of the fastener spaced from the bearing surface insertable through the aligned clip member and tab openings and securable to the tab with the clip member compressed between the first bearing surface and the tab member and so that the intermediate portion of the clip member is forced against the second surface of the second member thereby retaining the distal end of the tab member within the first member opening.

30. The assembly of claim 29 wherein the intermediate portion of the clip member includes a first fold line that bears against the second surface of the second member when the clip member is compressed.

31. The assembly of claim 30 wherein the clip angle is acute.

32. The assembly of claim 30 wherein the fastener member includes a second bearing surface at the second end, the clip member further including third, fourth and fifth clip segments, the third clip segment having first and second ends where the first end is integrally formed with the second clip segment along a second fold line opposite the first fold line, the fourth clip segment is integrally formed with the third clip segment along a third fold line at the second end of the third clip segment and the fifth clip segment is integrally formed with the fourth clip segment along a fourth fold line opposite the third fold line, the fourth clip segment including oppositely facing first and second surfaces and forming a third clip segment opening and the fifth clip segment including first and second oppositely facing surfaces and forming a fourth clip segment opening, wherein the second surface of the fourth clip segment faces the second surface of the fifth clip segment so that the facing second surfaces of the fourth and fifth clip segments form a second clip angle and, wherein, when force is applied between the first surface of the fourth clip segment and the first surface of the fifth clip segment, the fourth and fifth clip segments are resiliently forced together thereby reducing the second clip angle; and
wherein, with the first surface of the first member abutting the first surface of the second member and the tab member extending through the first member opening, the clip member is positionable so that the tab member is positioned between the first surface of the second clip segment and the first surface of the third clip segment with the tab opening and the first, second, third and fourth clip segment openings aligned and so that the first and fourth fold lines are adjacent the second surface of the second member, wherein the fastener is insertable through the aligned clip member and tab openings and with the first and second clip segments compressed between the first bearing surface and the tab member and the fourth and fifth clip segments compressed between the second bearing surface and the tab member so that the first and fourth fold lines are forced against the second surface of the second member thereby retaining the distal end of the tab member within the first member opening.

33. The assembly of claim 32 wherein the tab member includes a tab bracket that includes first and second substantially parallel arm members spaced apart by a shoulder member that traverses the distance between the arm members and wherein the first arm member forms the first tab opening and the second arm member forms a second tab opening that is aligned with the first tab opening.

34. The assembly of claim 33 wherein the tab bracket is formed of steel and is welded to the second member.

35. The assembly of claim 33 wherein the first member is a tube member having first and second oppositely facing wall members and an end edge, the end edge forming the first surface of the first member, the first and second arm members having distal ends opposite the shoulder member and, wherein, the tab bracket includes a bolt mounted between the first and second substantially parallel arm members, the bolt adjustable to change an expansion dimension between the distal ends of the arm members wherein, with distal ends of the first and second arm members located within the tube and adjacent the first and second wall members, the bolt can be adjusted to force the distal ends of the arm members against the first and second wall members thereby retaining the tab bracket in the end of the tube member adjacent the end edge of the tube member.

36. The assembly of claim 29 wherein the clip member is formed of steel.

37. The assembly of claim 32 wherein the fastener includes a bolt and a nut, the bolt including a head member that forms the first bearing surface and a threaded shaft that extends from the head, the nut forming the second bearing surface.
